(19) United States
(12) Patent Application Publication
(10) Pub. No.: US 2026/0114656 A1
(43) Pub. Date: Apr. 30, 2026

(54) COOKING DEVICE DRAWER, PREFERABLY STEAM COOKING DRAWER

(71) Applicant: Miele & Cie. KG, Gütersloh (DE)

(72) Inventors: Tim Otis Diestelhorst, Bünde (DE); Tino Bergmeier, Kirchlengern (DE)

(21) Appl. No.: 19/162,097

(22) PCT Filed: Feb. 14, 2024
(86) PCT No.: PCT/EP2024/053678

§ 371 Date: Sep. 4, 2025

(30) Foreign Application Priority Data
Mar. 8, 2023 (BE) 2023/5174

(51) Int. Cl. A47J 27/04

(52) U.S. Cl. CPC A47J 27/04; A47J 2027/043

(57) ABSTRACT

The invention relates to a cooking device drawer (1), preferably a steam cooking drawer (1), comprising an inner housing (11) which at least partly forms a cooking chamber (12), wherein the cooking chamber (12) is designed to receive at least one cooking utensil (17) from above in the vertical direction (Z) through an access opening (13). The cooking device drawer (1) is characterized by at least one actuation unit (18), preferably multiple actuation units (18) which are designed to at least partly raise a cooking utensil (17) received in the cooking chamber (12) in the vertical direction (Z) so as to be aligned in the horizontal (X, Y) or diagonally to the horizontal (X, Y) relative to the inner housing (11).

### CROSS-REFERENCE TO PRIOR APPLICATIONS

This application is a U.S. National Phase application under 35 U.S.C. § 371 of International Application No. PCT/EP2024/053678, filed on Feb. 14, 2024, and claims benefit to Belgian Patent Application No. BE 2023/5174, filed on Mar. 8, 2023. The International Application was published in German on Sep. 12, 2024 as WO/2024/184030 under PCT Article 21(2).

### FIELD

The invention relates to a cooking appliance drawer, preferably a steam cooking drawer.

### BACKGROUND

For the preparation of foods, which can also be referred to as items to be treated or items to be cooked, various kitchen appliances are known, which can also be referred to as cooking appliances. These include cooktops on which the item to be cooked can be prepared in a cookware item, for example, in a pot with or without a lid, in a pan, and the like, by cooking, roasting, and the like.

Further, there are known cooking appliances which have a cooking chamber that is configured in immovable (i.e., stationary) relationship with the cooking appliance and in which the item to be cooked can be placed in or on a cookware item and cooked while the cooking chamber of the cooking appliance is closed. A cooking appliance of this type can be, for example, an oven, a steam cooker, a microwave, a combination appliance composed of an oven with a steam cooker and/or with a microwave, and the like. At least in Germany, such cooking appliances with a stationary cooking chamber typically have an overall height (in the vertical direction) of about 45 cm, but ovens with an overall height of about 60 cm are also common.

Such cooking appliances with a stationary cooking chamber have in common that they have an outer housing as an outer enclosure that substantially encloses the cooking appliance outwardly, protecting the individual components and elements thereof and allowing them to be handled together. Formed within the cooking appliance is an interior space which constitutes the cooking chamber and is substantially enclosed by an inner housing as an inner enclosure, also referred to as the cooking chamber shell or oven shell. Between the inner enclosure and the outer enclosure, a housing space is formed as an interstitial space in which may be disposed functional elements of the cooking appliance, such as a controller or control unit, an electrical power supply, and other components that serve the intended use of the cooking appliance. As viewed in the depth direction from the front, i.e. from the perspective of a user, the outer enclosure or a front panel in the form of a furniture material or in the form of a control panel and the like, together with the inner enclosure, encloses the housing space so that the housing space is not accessible to the user.

As viewed along the depth, the interior space of the cooking appliance has a front-facing through-opening as an access opening through which the interior space of the cooking appliance is accessible to the user, allowing the user to insert and position cookware items in the interior space of the cooking appliance as its cooking chamber and to take out and remove cookware items from the interior space of the cooking appliance after the treatment of the item to be cooked is complete. The user can open the access opening by means of a closure element, for example, in the form of a side-swinging door, a drop-down door, and the like, in order to gain access to the interior space of the cooking appliance as previously described, or to close the interior space of the cooking appliance and perform the cooking operation or process. Such a closure element may be of a closed design or may have a viewing window to allow the user to look into the closed interior space of the cooking appliance.

Such cooking appliances with a stationary cooking chamber are typically designed as built-in appliances or built-in kitchen appliances to be fixedly disposed in a space-saving manner with their outer enclosure in kitchen furniture, such as built-in kitchen cabinets, at a vertical height that is easily accessible to the user and such that their closure element and, if present, also their front panel (see above) is/are flush with the surfaces of the other cooking appliances, drawers, doors, and the like, of the kitchen furniture, as viewed looking toward the user, which can improve the visual appearance to the user.

Also known are other built-in kitchen appliances, such as those with warming drawers, vacuum sealing drawers, and the like, which are installed in the kitchen as described hereinbefore and, in particular, combined with the above-described cooking appliances as built-in appliances and arranged horizontally above one another and/or vertically adjacent to one another. Warming drawers are used, for example, to keep the cooked food warm without further cooking and to preheat dishes. In vacuum sealing drawers, food items can be sealed under vacuum in an airtight package.

Such drawers as kitchen appliances are basically constructed similarly to the previously described cooking appliances with a stationary cooking chamber. However, drawers are significantly flatter, i.e. smaller in the vertical direction, and must therefore be pulled forwardly out of the kitchen furniture unit by the user toward himself/herself in order to allow access to the interior space thereof vertically from above. For this purpose, the movable part of the drawer, which can also be referred to as a pull-out box, has a pull-out box bottom, which serves to receive, for example, the cookware vertically from above and may be configured to be movable in the depth direction relative to the inner enclosure of the drawer, for example via rails arranged in the transverse direction laterally. The pull-out box bottom usually has a vertically oriented front panel in the depth direction toward the front, the front panel closing the interior space of the drawer or its access opening in the closed state.

At least in Germany, such drawers, also called built-in drawers, usually have a height of about 15 cm in the vertical direction. Drawers are usually disposed vertically below a cooking appliance with a stationary cooking chamber, for example, below an oven, below a steam cooker, and the like, or combined and vertically stacked with another drawer, but can also be built individually and independently into a kitchen furniture unit. Since, at least in Germany, the installation spaces for built-in kitchen appliances in kitchen furniture, which can also be referred to as niches, usually have a vertical height of about 60 cm, a drawer having an overall height of about 15 cm and a cooking appliance with a stationary cooking space having an overall height of about 45 cm can, in particular, be modularly combined and used as built-in appliances.

Also known are cooking appliances with a steam cooking function which are configured as built-in drawers and can be referred to as steam cooking drawers. Such steam cooking drawers usually receive at least one cooking container with food to be cooked in their cooking chamber, which is located on the pull-out box bottom. The cooking container is usually removable, typically upwardly out of the open built-in drawer. Accordingly, the access opening to the cooking chamber of steam cooking drawers is horizontal and usually rectangular and can usually be closed and opened by a pivotable lid. The pivotable lid is usually mounted at the rear edge of the steam cooking drawer facing away from the front panel such that it is pivotable upwardly.

Drawers having a steam cooking function are disclosed in patent publications DE 10 2020 105 691 A1 and DE 10 2021 204 743 A1.

Patent publication WO 2007 061 323 A1 shows designing a cooking appliance generally as a drawer.

With steam cooking drawers and other cooking appliance drawers, it is known not to place the food item to be cooked directly into the interior space, but to use a cookware item, a cooking container or a cooking dish, so that the item to be cooked is placed in or on the cookware item, and the cookware item, together with the item to be cooked, is then placed, slid, or hung into/in the interior space of the steam cooking drawer or cooking appliance drawer, depending on the particular design of the cooking appliance. This can make preparation easier for the user, since the cookware item can be filled with the foodstuff outside the steam cooking drawer or cooking appliance drawer and only then placed into the interior space. Conversely, the cookware item holding the foodstuff can be removed from the interior space of the steam cooking drawer or cooking appliance drawer, whereupon the finished food can be removed from the cookware item. This can also simplify cleaning for the user, since the separate cookware item can be cleaned more easily and possibly using a dishwasher. In any case, the cooking chamber may, in this case, be formed by the interior space of the cookware item when the cookware item is disposed in the interior space of the steam cooking drawer or cooking appliance drawer to perform the cooking process.

With regard to such cookware items, it is known to remove them laterally or forwardly from the interior space of a steam cooker, an oven, a microwave, a combination appliance, or the like. In the interior space, the cookware items may rest on a rack or on a rib of the cooking chamber wall. With such appliances, the cookware items can accordingly be moved and pulled out by the user, for example, using a potholder or a dish towel to protect against burns, and can then more easily grasped by gripping around an edge for removal thereof.

With steam cooking drawers or cooking appliance drawers, a disadvantage is that the cookware items usually have to be removed from above. Moreover, in the case of steam cooking drawers or cooking appliance drawers, due to the small overall height, as much of the available space as possible should be used to form the cooking chamber and, therefore, the cookware items cannot be moved laterally or back and forth in the horizontal in order to grip them from behind. This can make it more difficult for the user to remove the cookware item, especially in the case of hot cookware, using a potholder or the like.

There are generally known cookware items having so-called “drop-down handles,” which are U-shaped and disposed laterally on the cookware item. The upper, elongated, horizontally oriented portion of the U-shape member of the drop-down handle can be grasped by the user with their fingers and pulled up until a laterally accessible rectangular handle recess is formed between the three-sided U-shape member and the top side of the flange of the cookware item and the movement of the U-shape member is positively blocked against the underside of the flange of the cookware item. Then, the user can grip laterally behind the U-shape member of the drop-down handle to be able to safely lift the cookware item. However, this is only practicable during placement of the cookware item, when the U-shape members of the drop-down handles are cold and can be grasped directly with the fingers or hands. When the U-shape members of the drop-down handles are hot, a potholder or the like is needed to avoid burns, which, however, can make it more difficult or even impossible for the user to grip and pull up the flat-lying upper, elongated, horizontally oriented portions of the U-shape member of the drop-down handle.

### SUMMARY

In an embodiment, the present invention provides a cooking appliance drawer, comprising: an inner enclosure, a part of the inner enclosure forming a cooking chamber, the cooking chamber being configured to receive at least one cookware item through an access opening from above in a vertical direction; and at least one actuating unit configured to lift at least a portion of the at least one cookware item relative to the inner enclosure, either while oriented in a horizontal direction or at an angle relative to the horizontal direction, wherein the at least one actuating unit has at least one lifter configured and adapted to be moved in the vertical direction by an actuating element of the at least one actuating unit, and wherein the at least one actuating unit is configured and adapted to lift the at least one cookware item relative to the inner enclosure by means of the at least one lifter.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of a kitchen furniture unit with an inventive cooking appliance drawer in the form of a steam cooking drawer according to a first exemplary embodiment, shown in the retracted position;

FIG. 2 is a view corresponding to FIG. 1, but showing the steam cooking drawer in the extended position;

FIG. 3 is a perspective detail front view obliquely from above of the extended steam cooking drawer of FIG. 2;

FIG. 4 is a simplified plan view of an extended steam cooking drawer of FIGS. 2 and 3;

FIG. 5 is a simplified plan view of an extended steam cooking drawer according to a second exemplary embodiment;

FIG. 6 is a schematic longitudinal section through a steam cooking drawer according to a first or second exemplary embodiment, shown with the cookware item in a lifted condition;

FIG. 7 is a view similar to FIG. 6, but showing the cookware item in a lowered condition;

FIG. 8 is a detail view of the actuating unit of FIG. 7;

FIG. 9 is a detail view of an actuating unit according to a third exemplary embodiment; and

FIG. 10 is a detail view of an actuating unit according to a fourth exemplary embodiment.

### DETAILED DESCRIPTION

In an embodiment, the present invention provides a way of making it easier for a user to remove a cookware item from a cooking appliance drawer, and particularly from a steam cooking drawer, and, in particular, of making it easier than heretofore, or possible in the first place, to grasp a cookware item accommodated therein from above. In an embodiment this is accomplished, in particular, for hot cookware items. In an embodiment this is accomplished in a most simple, space-saving, user-friendly, and/or cost-effective manner.

In an embodiment, the present invention provides a cooking appliance drawer, preferably a steam cooking drawer, having an inner enclosure, part of which forms a cooking chamber, the cooking chamber being configured to receive at least one cookware item through an access opening from above in the vertical direction.

The cooking appliance drawer features at least one actuating unit, preferably a plurality of actuating units, configured and adapted to lift at least a portion of a cookware item received in the cooking chamber in the vertical direction relative to the inner enclosure, either while oriented in the horizontal or at an angle relative to the horizontal.

In other words, a cookware item disposed in the interior space or in the cooking chamber of the inner enclosure can be pushed or moved upward in the vertical direction from below by the actuating unit to make it easier for the user to grasp the cookware item. In particular, it can thus be made easier or possible in the first place for the user to grip behind an edge of the cookware item, in particular with a potholder or the like to protect the fingers from burns, and thereby be able to grasp and lift the cookware item in as safe a manner as possible. This may increase the comfort of using the cooking appliance drawer and, in particular of a steam cooking drawer. In particular, this can protect the user from burns.

The lifting of the accommodated cookware item in the vertical direction relative to the inner enclosure can be performed either while oriented in the horizontal or at an angle relative to the horizontal, depending on the design and arrangement of the actuating unit or a plurality of actuating units.

Thus, by means of an actuating unit disposed as directly as possible below the center of gravity of the accommodated cookware item or by means of a plurality of actuating units arranged uniformly around the center of gravity of the accommodated cookware item, the cookware item can be lifted in a horizontal orientation, i.e., without tilting the cookware item relative to the horizontal. This can prevent movement of the foodstuff within the cookware item and, for example, mixing of multiple foodstuffs within the cookware item.

Alternatively, an inclination or tilt of the accommodated cookware item during lifting can be deliberately achieved by at least one actuating unit and, possibly, a plurality of actuating units respectively being disposed at an offset from the center of gravity of the accommodated cookware item. In the case of a steam cooking drawer, for example, this can allow condensed water adhering to the underside of the cookware item to accumulate and thereby drip off more easily. The can reduce the amount of condensed water which adheres to the cookware item during removal of the cookware item from the interior space or from the cooking chamber to the steam cooking drawer and which may therefore drip or run off outside the steam cooking drawer.

In accordance with an aspect of the invention, the inner enclosure has a flange, at least in some portions, the flange being configured to receive thereon a flange of the cooking item in the vertical direction from above, at least one actuating unit, preferably a plurality of actuating units, being configured and adapted to lift at least a portion of a flange of a cookware item received in the cooking chamber in the vertical direction relative to the flange of the inner enclosure, either while oriented in the horizontal or at an angle relative to the horizontal. Implementing the previously described features and advantages peripherally with respect to the cooking chamber can reduce the space required therefor in the vertical direction, which can be particularly relevant in the case of cooking appliance drawers in order to be able to use the height of the cooking appliance drawer substantially entirely for performing the cooking process.

In accordance with another aspect of the invention, the actuating unit has at least one lifter configured and adapted to be moved in the vertical direction by an actuating element of the actuating unit, the actuating unit being configured and adapted to lift the cookware item relative to the inner enclosure by means of the lifter. This can provide a particularly simple and functional way of implementing such a vertical movement.

In accordance with a further aspect of the invention, the actuating element is a push-to-open mechanism. In other words, the vertical movement of the lifter can be caused by the user using a mechanism similar to those known from handleless drawers and furniture doors, this being accomplished in that the actuating element is pushed in and thereby loaded by the cookware item as it is placed into the interior space or into the cooking chamber, and in that in order to remove the cookware item, the user can press on the cookware item again to cause the cookware item to be lifted by the mechanism. This can be a particularly simple and drive-free implementation option that does not require electricity or associated wiring.

In accordance with another aspect of the invention, the actuating element is a drive, preferably a linear drive or a heatable expansion element. This can be an alternative implementation option. This can be advantageous in that the user must become active only indirectly, for example, by pressing a button or the like, for example in the area of a front panel of the cooking appliance drawer, in order to activate the drive and thereby move the lifter up or down. Moreover, this can make it possible for the user not to have to operate the drive at all, this being accomplished in that the lifter can moved up and down automatically, for example, in response to another action, such as pulling out or pushing in the cooking appliance drawer or opening or closing a closure element or lid of the cooking appliance drawer, as will be described in more detail further below. This can relieve the user of this task and further increase the comfort of using the cooking appliance drawer.

In accordance with a further aspect of the invention, the cooking appliance drawer further has a closure element, preferably a lid, configured for closing and clearing the access opening to the cooking chamber, preferably by being pivoted by means of a pivoting element, preferably a hinge, the cooking appliance drawer being configured and adapted to detect when the closure element clears the access opening to the cooking chamber and, in response to the detected clearance, to move the lifter up in the vertical direction by means of the drive, and to otherwise preferably move the lifter down in the vertical direction by means of the drive. This can enable the practical implementation of the previously described function.

Clearing and closing may, for example, be detected in a sensor-based manner by relieving or loading a pressure sensor or by a capacitive sensor detecting or not detecting a counterpart. This can also be accomplished by making and breaking of an electrical contact. Moreover, this can be accomplished based on control information such as, for example, based on the automatic opening or closing of a closure element by means of a corresponding drive. In any case, this allows the lifter to move in and out automatically.

In accordance with another aspect of the invention, the cooking appliance drawer is configured to distinguish between the presence and absence of a cookware item in the cooking chamber, preferably on the flange of the inner enclosure, by means of a sensor and/or based on a parameter of the drive, in particular a drive load, the cooking appliance drawer being configured and adapted such that, in response to the detected clearance, it will move the lifter up in the vertical direction by means of the drive only if the presence of a cookware item is detected at the same time, and that it will otherwise preferably move the lifter down in the vertical direction by means of the drive. This makes it possible to prevent movement of the lifter in the event that no cookware is present in the cooking chamber or in the interior space.

In accordance with a further aspect of the invention, the lifter of the actuating element is sealed fluid-tight with respect to the cookware item by means of a seal. This can protect the interstitial space from moisture and/or soiling

In accordance with another aspect of the invention, the seal seals a through-hole of the inner enclosure, preferably of a flange of the inner enclosure, around the lifter of the actuating element, and the lifter of the actuating element is movable in the vertical direction through the seal. This can be a particularly simple sealing option, although a portion of the lifter therefore projects upwardly where it can come into contact with moisture and/or dirt, which then have/has to be kept away from the interstitial space by the seal.

In accordance with another aspect of the invention, the seal envelops a through-hole of the inner enclosure, preferably of a flange of the inner enclosure, with respect to the cookware item, and the lifter of the actuating element is movable in the vertical direction below the seal. This can ensure that the lifter, and thus also the interstitial space, is always protected from moisture and/or soiling. However, this can increase the complexity of implementation of a seal.

In accordance with a further aspect of the invention, the seal is pleated in shape or elastic to allow movement of the lifter of the actuating element in the vertical direction. These can be options for practical implementation.

In accordance with another aspect of the invention, a seal edge of the seal surrounds an edge of the through-hole of the inner enclosure, preferably a flange of the inner enclosure, on both sides in form-fitting and/or frictional engagement therewith. This can be accomplished by a double-walled or U-shaped configuration of the seal edge of the seal, which accordingly is capable of receiving the edge of the through-hole of the inner enclosure and surrounding it on both sides. This can enable simple assembly while at the same time ensuring the desired tightness. Moreover, this can simplify the replacement of a defective seal.

In accordance with a further aspect of the invention, the through-hole of the inner enclosure, preferably of a flange of the inner enclosure, is at least partially, preferably completely, surrounded by a, preferably circular, ridge of the inner enclosure, preferably of a flange of the inner enclosure. This makes it possible to keep liquid, such as, for example, condensed water away from the through-hole of the inner enclosure or the edge thereof.

In accordance with another aspect of the invention, the inner enclosure, preferably a flange of the inner enclosure, is configured to slope downwardly toward the cooking chamber, at least in a portion around the through-hole of the inner enclosure, preferably of a flange of the inner enclosure. This can additionally or alternatively keep liquid, such as, for example, condensed water away from the through-hole of the inner enclosure or the flange thereof, which can relieve the seal.

The above figures are viewed in Cartesian coordinates. A longitudinal direction X can also be referred to as depth X or length X. Perpendicular to longitudinal direction X is a transverse direction Y, which can also be referred to as width Y. A vertical direction Z, which can also be referred to as height Z and corresponds to the direction of gravity, is perpendicular to both the longitudinal direction X and the transverse direction Y. Longitudinal direction X and transverse direction Y together define the horizontal X, Y, which can also be referred to as horizontal plane X, Y.

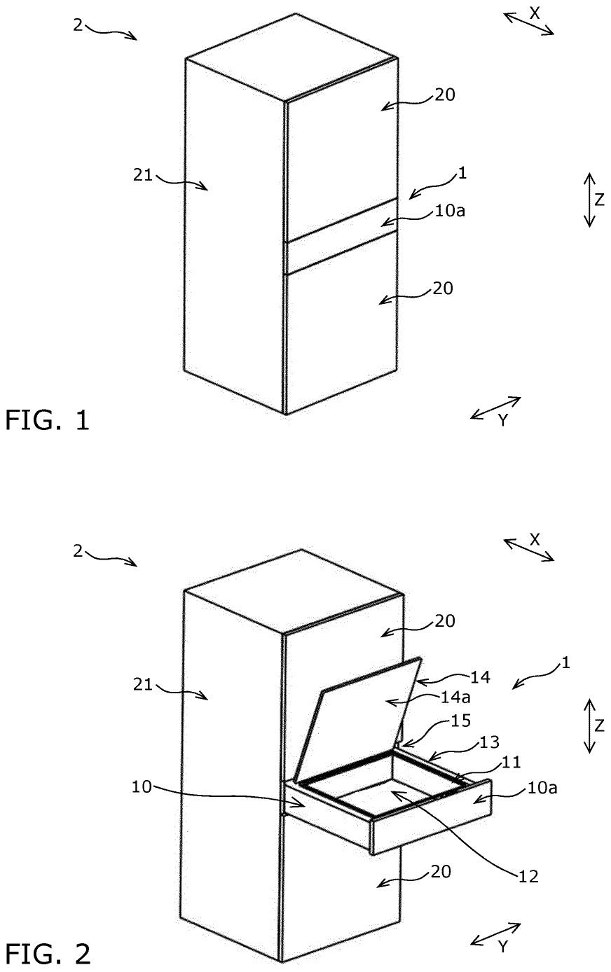

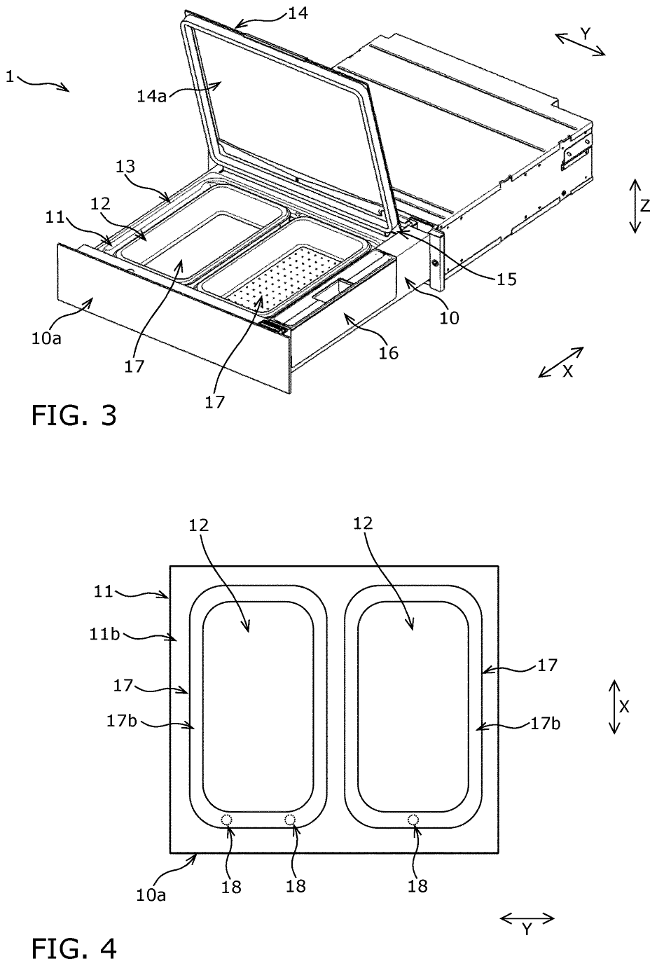

FIG. 1 depicts a perspective view of a kitchen furniture unit 2 with an inventive cooking appliance drawer 1 in the form of a steam cooking drawer 1 according to a first exemplary embodiment, shown in the retracted position. FIG. 2 shows a view corresponding to FIG. 1, but with steam cooking drawer 1 in the extended position. FIG. 3 shows the extended steam cooking drawer 1 of FIG. 2 in a perspective detail front view obliquely from above.

Kitchen furniture 2, which can also be referred to as kitchen cabinet run 2, has a furniture front 20 or a plurality of furniture front panels 20 facing a user and forming the front end of kitchen furniture unit 1 in longitudinal direction X. Furniture front 20 is formed by several doors, hinged panels, and the like (not labeled), and possibly drawers, which are pivotably, hingedly, or extendibly mounted on a frame 21, framework 21, or carcass 21 of kitchen furniture unit 2.

A steam cooking drawer 1 according to the invention is disposed approximately centrally along vertical direction Z between two furniture fronts 20. Steam cooking drawer 1 has an outer enclosure 10, which can also be referred to as outer housing 10 and substantially delimits or encloses steam cooking drawer 1 outwardly. Outer enclosure 10 terminates along longitudinal direction X toward the front, i.e., toward the user, in a front panel 10a, which is flush with furniture fronts 20 of kitchen furniture unit 2 when steam cooking drawer 1 is in the retracted position (see FIG. 1). A pair of telescopic rails is mounted on outer enclosure 10 laterally in transverse direction Y, so that steam cooking drawer 1 can be extended and retracted in longitudinal direction X relative to frame 20 of the kitchen furniture unit 2.

Disposed within outer enclosure 10 is an inner enclosure 11, which can also be referred to as inner housing 11. Inner enclosure 11 terminates in outer enclosure 10 rearwardly and forwardly up to front panel 10a in longitudinal direction X, downwardly in vertical direction Z, and at both sides in transverse direction Y, so that an interstitial space is formed between outer enclosure 10 and in inner enclosure 11, which can also be referred to as housing space. This interstitial space represents the interior of steam cooking drawer 1.

Furthermore, inner enclosure 11 substantially encloses an interior space 12, in which a cooking process or a steam cooking process can be carried out. For this purpose, a steam generator is disposed in the housing space or interstitial space of steam cooking drawer 1, the steam generator being capable of evaporating water into steam and conveying the steam into interior space 12. The water can be provided by a removable water tank 16 (see FIG. 3). Accordingly, interior space 12 can also be referred to as cooking chamber 12. If interior space 12 of steam cooking drawer 1 chamber receives a plurality of cookware items 17, such as, for example, two cookware items 17 of the same size disposed side by side in transverse direction Y (see FIG. 3), then cooking chamber 12 is formed by the interior spaces (not labeled) of cookware items 17. Cookware items 17 can also be referred to as cooking containers 17 or as cooking dishes 17.

Interior space 12 is accessible to the user in vertical direction Z from above through an access opening 13. Access opening 13 can be closed and opened by means of a closure element 14 in the form of a lid 14. For this purpose, lid 14 is attached to outer enclosure 10 of steam cooking drawer 1 by means of at least one pivoting element 15 in the form of a hinge 15 or a lid hinge 15 such that it can be pivoted upward in vertical direction Z, so that the user can pivot lid 14 upward away from himself/herself and toward the furniture front panel 20 located thereabove in order to be able to access cooking chamber 12 when steam cooking drawer 1 is in the extended position (see FIGS. 2 and 3). When lid 14 is pivoted down into horizontal X, Y, cooking chamber 12 is closed and steam cooking drawer 1 can be pushed into kitchen furniture unit 2 (see FIG. 1). An underside 14a or inner side 14a of lid 14 faces cooking chamber 12.

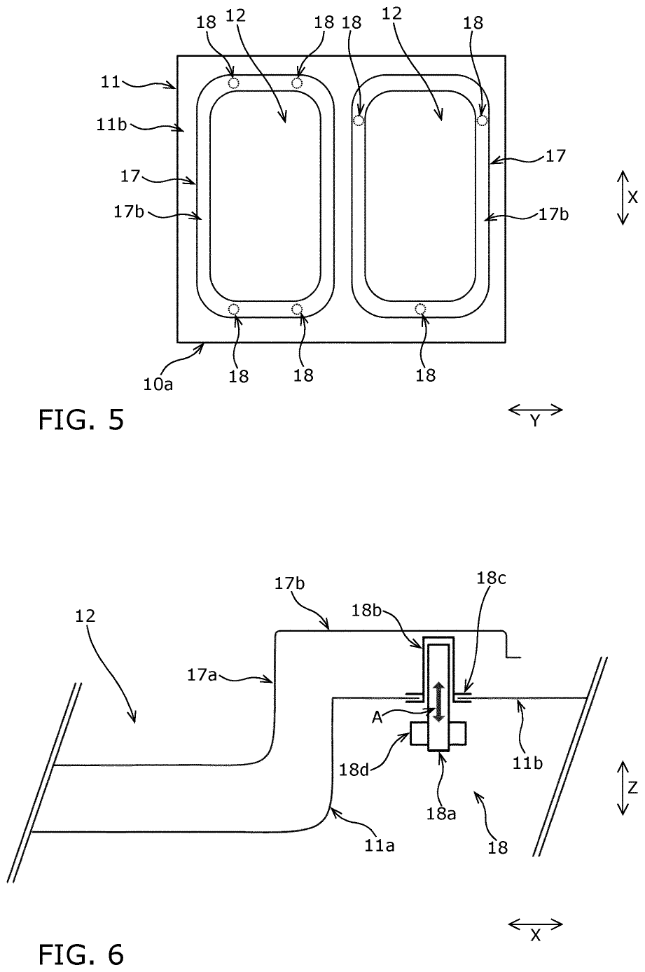

FIG. 4 shows a simplified plan view of an extended steam cooking drawer 1 of FIGS. 2 and 3. FIG. 5 shows a simplified plan view of an extended steam cooking drawer 1 according to a second exemplary embodiment.

In either case, according to the invention, steam cooking drawer 1 is provided with a plurality of actuating units 18 on a flange 11b of inner enclosure 11, which each to lift a cookware item 17 received by steam cooking drawer 1 in its interior space 12 upward in vertical direction Z by pressing peripherally from below, which will be described in more detail below with regard to various options for practical implementation. In any case, an actuating unit 18 can also be referred to as removal unit 18 or as lifting unit 18.

In the case of the steam cooking drawer 1 of FIG. 4, an actuating unit 18 for lifting the right cookware item 17 is provided centrally under its front flange 17b, i.e., the flange oriented toward front panel 10a, to lift the front edge of the right cookware item 17. In the case of the left cookware item 17 of the steam cooking drawer 1 of FIG. 4, a pair of actuating units 18 which are spaced apart in transverse direction Y is provided for the same purpose. In either case, this allows the user to grip behind the front edge (not labeled) of cookware item 17 and thus relatively easily lift or remove cookware item 17 from interior space 12 of steam cooking drawer 1, even with a potholder or the like. In addition, cookware item 17 can be inclined rearwardly at an angle relative to the horizontal X, Y in the process, so that steam of the steam cooking process condensed on the outside or underside of the base of cookware item 17 can accumulate and run off toward the rear in order for it to remain within inner space 12 of steam cooking drawer 1.

In the steam cooking drawer 1 of FIG. 5, two pairs of actuating units 18 are disposed opposite each other in longitudinal direction X on the left. On the right, three actuating units 18 form an equilateral triangle. In either case, cookware item 17 can be lifted in vertical direction Z while oriented in horizontal X, Y so as not to mix the foodstuff inside cookware item 17 by tilting.

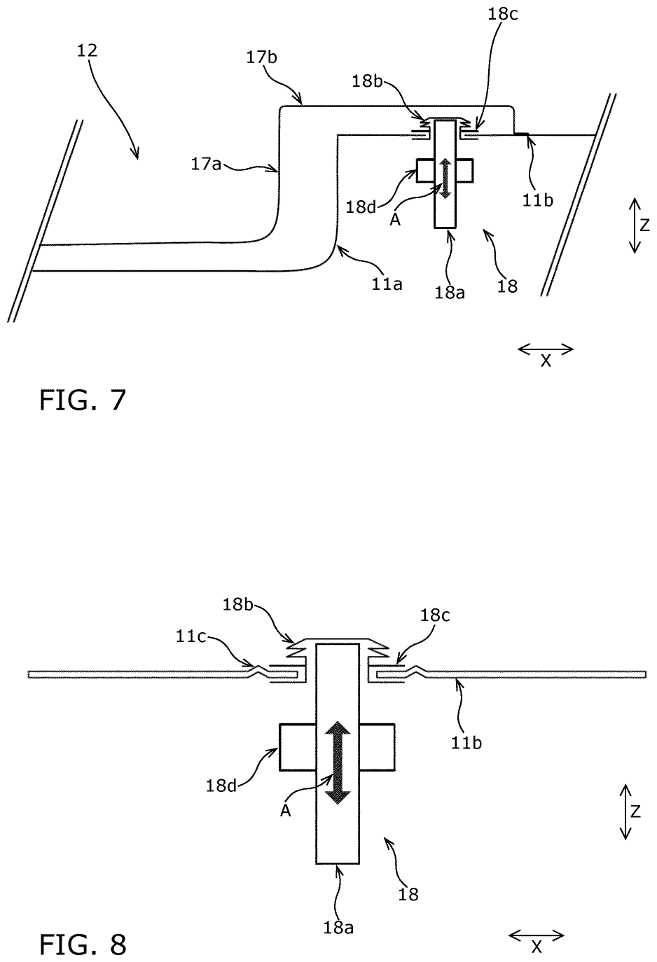

FIG. 6 depicts a schematic longitudinal section through a steam cooking drawer 1 according to a first or second exemplary embodiment, showing the cookware item 17 in a lifted condition. FIG. 7 shows a view similar to FIG. 1, but with cookware item 17 in a lowered condition.

In addition to the previously mentioned flange 11b extending in horizontal X, Y, inner enclosure 11 has a wall 11a perpendicular thereto, which surrounds interior space 12. The previously mentioned flange 17b of cookware item 17 extends parallel to and above flange 11b of inner enclosure 11. This applies likewise to a wall 17a of cookware item 17.

As described earlier with reference to FIGS. 4 and 5, at least one actuating unit 18 is disposed in the region of flange 11b of inner enclosure 11 in such a manner that flange 17b of cookware item 17 rests on actuating unit 18 from above when cookware item 17 is placed in the interior space 12. Actuating unit 18 has a lifter 18a capable of being moved up and down in a direction of movement A in vertical direction Z. This movement is produced by an actuating element 18d, which may be a push-to-open mechanism 18d or a drive 18d such as, for example, a linear drive 18d or a heatable expansion element 18d.

Accordingly, lifter 18a can be retracted into flange 11b of inner enclosure 11 so as to allow cookware item 17 to rest with its flange 17b directly on flange 11b of inner enclosure 11 (see FIG. 7). Or else, lifter 18a can be extended by actuating element 18d upwardly out of flange 11b of inner enclosure 11 in vertical direction Z so as to lift cookware item 17 relative to inner enclosure 11 (see FIG. 6).

In any case, a seal 18b can be provided to keep liquids and dirt away from actuating unit 18 and from the interstitial space (not labeled) in which actuating unit 18 is disposed.

FIG. 8 shows the actuating unit of FIG. 7 in a detail view, so that its seal 18b, which is pleated in shape and completely surrounds lifter 18a upwardly, can be depicted in enlarged scale. Seal 18b is disposed with its seal edge 18c in form-fitting and/or frictional engagement with the edge (not labeled) of that through-hole (not labeled) of flange 11b of inner enclosure 11 through which lifter 18a can be moved. Further, the through-hole of flange 11b of inner enclosure 11 is surrounded by a circular ridge 11c of flange 11b of inner enclosure 11 to keep liquids away from the through-hole.

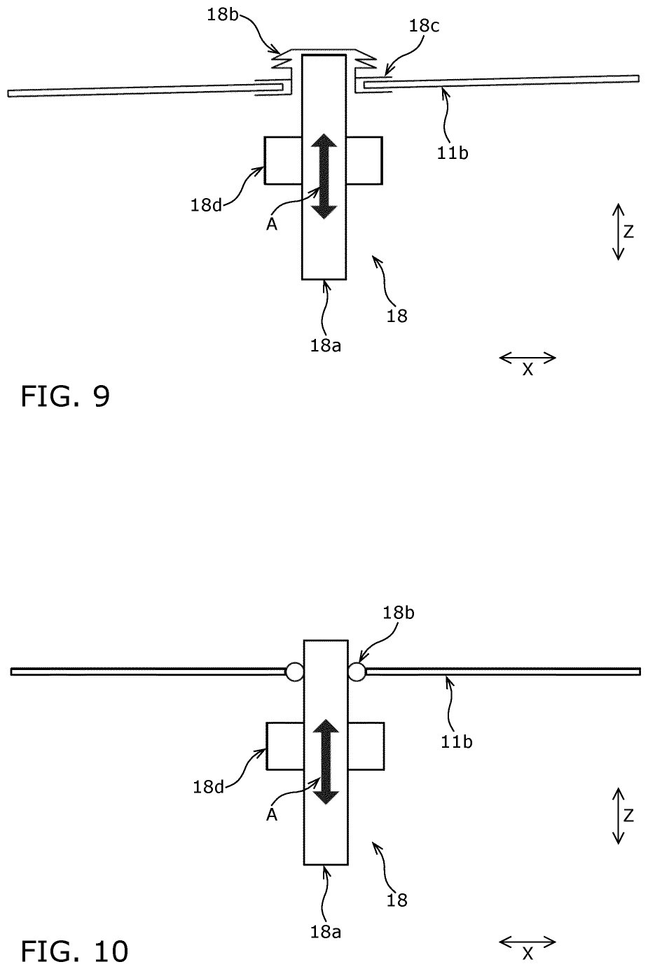

FIG. 9 shows a detail view of an actuating unit 18 according to a third exemplary embodiment. In this case, instead of circular ridge 11c of flange 11b of inner enclosure 11, flange 11b of inner enclosure 11 is provided with a downward slope to allow liquids to more easily run off toward cooking chamber 12, thus keeping them away from the through-hole of flange 11b of inner enclosure 11.

FIG. 10 shows a detail view of an actuating unit 18 according to a fourth exemplary embodiment. In this case, the upper portion of lifter 18a projects upwardly out of flange 11b of inner enclosure 11, and seal 18b is disposed annularly around lifter 18a on the edge of the through-hole of flange 11b of inner enclosure 11.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

A direction of movement of the lifter
X longitudinal direction; depth; length
Y transverse direction; width
Z vertical direction; height
X, Y horizontal; horizontal plane
1 cooking appliance drawer; steam cooking drawer
10 outer enclosure; outer housing
10a front panel
11 inner enclosure; inner housing
11a wall of inner enclosure 11
11b flange of inner enclosure 11
11c (circular) ridge of flange 11b of inner enclosure 11
12 interior space; cooking chamber
13 access opening
14 closure element; lid
14a underside or inner side of lid 14
15 pivoting element; hinge; lid hinge
16 water tank
17 cookware item; cooking container; cooking dish
17a wall of cookware item 17
17b flange of inner cookware 17
18 actuating unit; removal unit; lifting unit
18a lifter
18b sea
18c seal edge
18d actuating element; push-to-open mechanism; drive; linear drive; heatable expansion element
2 kitchen furniture unit; kitchen cabinet run
20 furniture front; furniture front panel
21 frame; framework; carcass

1. A cooking appliance drawer, preferably a steam cooking drawer, comprising:
an inner enclosure, a part of the inner enclosure forming cooking chamber
the cooking chamber being configured to receive at least one cookware item through an access opening from above in a vertical direction; and
at least one actuating unit, preferably a plurality of actuating units configured to lift at least a portion of the at least one cookware item received in the cooking chamber in the vertical direction relative to the inner enclosure, either while oriented in a horizontal direction or at an angle relative to the horizontal direction,
wherein
the at least one actuating unit has at least one lifter configured and adapted to be moved in the vertical direction (Z) by an actuating element of the at least one actuating unit, and
wherein the at least one actuating unit is configured and adapted to lift the at least one cookware item relative to the inner enclosure by means of the at least one lifter.

2. The cooking appliance of claim 1,
wherein the inner enclosure, at least in some portions, a flange, the flange being configured to receive thereon a flange of the at least one cookware item in the vertical direction from above, and
wherein the at least one actuating unit, preferably a plurality of actuating units, is configured and adapted to lift at least a portion of a flange of the at least one cookware item received in the cooking chamber in the vertical direction relative to the flange of the inner enclosure, either while oriented in the horizontal direction or at an angle relative to the horizontal direction.

3. The cooking appliance drawer of claim 1,
wherein the at least one actuating element includes a drive configured as a push-to-open mechanism,
and/or
wherein the at least one actuating element includes a drive preferably configured as a linear drive (18d) or as a heatable expansion element.

4. The cooking appliance drawer of claim 3,
further comprising:
a closure element, preferably a lid, configured to close and clear the access opening to the cooking chamber, preferably by being pivoted by means of a pivoting element preferably a hinge
wherein the cooking appliance drawer configured to detect when the closure element clears the access opening to the cooking chamber as a detected clearance, and, in response to the detected clearance, to move the at least one lifter up in the vertical direction by means of the drive and to otherwise preferably move the lifter down in the vertical direction by means of the drive.

5. The cooking appliance drawer of claim 4,
wherein the cooking appliance drawer is configured to distinguish between a presence and an absence of the at least one cookware item in the cooking chamber, preferably on the flange of the inner enclosure, by means of a sensor and/or based on a parameter of the drive, in particular a drive load, and
wherein the cooking appliance drawer is configured and adapted such that, in response to the detected clearance, it will move the at least one lifter up in the vertical direction by means of the drive only if the presence of the at least one cookware item is detected at a same time, and that it will otherwise preferably move the lifter down in the vertical direction by means of the drive.

6. The cooking appliance drawer of claim 1,
wherein the at least one lifter of the actuating element is sealed fluid-tight with respect to the at least one cookware item by means of a seal.

7. The cooking appliance drawer of claim 1,
wherein the seal seals a through-hole of the inner enclosure, preferably of a flange of the inner enclosure, around the at least one lifter of the actuating element, the at least one lifter of the actuating element being movable in the vertical direction through the seal,
or
wherein the seal envelops a through-hole of the inner enclosure preferably of a flange of the inner enclosure, with respect to the at least one cookware item, and the at least one lifter of the actuating element is movable in the vertical direction below the seal.

8. The cooking appliance drawer of claim 7,
wherein the seal is pleated in shape or elastic so as to allow movement of the at least one lifter of the actuating element in the vertical direction.

9. The cooking appliance drawer of claim 7,
wherein a seal edge of the seal surrounds an edge of the through-hole of the inner enclosure, preferably a flange of the inner enclosure, on both sides in form-fitting and/or frictional engagement therewith.

10. The cooking appliance drawer of claim 1,
wherein a through-hole of the inner enclosure preferably of a flange of the inner enclosure, is at least partially preferably completely, surrounded by a, preferably circular, ridge of the inner enclosure, preferably of a flange of the inner enclosure.

11. The cooking appliance drawer of claim 10,
wherein the inner enclosure, preferably a flange of the inner enclosure, is configured to slope downwardly toward the cooking chamber, at least in a portion around the through-hole of the inner enclosure preferably of a flange of the inner enclosure.
